(19) United States
(12) Patent Application Publication
(10) Pub. No.: US 2023/0102190 A1
(43) Pub. Date: Mar. 30, 2023

(54) NEGATIVE ELECTROACTIVE MATERIALS AND METHODS OF FORMING THE SAME

(71) Applicants: GM GLOBAL TECHNOLOGY OPERATIONS LLC, Detroit, MI (US); BROWN UNIVERSITY, Providence, RI (US)

(72) Inventors: Xingcheng XIAO, Troy, MI (US); Mark VERBRUGGE, Troy, MI (US); Mok Yun JIN, Providence, RI (US); Brian W. SHELDON, Brookline, MA (US)

(73) Assignees: GM GLOBAL TECHNOLOGY OPERATIONS LLC, Detroit, MI (US); BROWN UNIVERSITY, Providence, RI (US)

(21) Appl. No.: 17/489,260

(22) Filed: Sep. 29, 2021

(51) Int. Cl. H01M 4/38; H01M 4/04; H01M 10/0525

(52) U.S. Cl. CPC H01M 4/386; H01M 4/0471; H01M 10/0525; H01M 2004/021

(57) ABSTRACT

Methods for preparing a silicon-based electroactive material for use in an electrochemical cell are provided. The methods include heating a silicon oxide (SiOₓ, where 0.1≤x≤2) particle to a temperature between about 600° C. and about 1200° C. over a period between about 30 minutes and about 10 hours to form the silicon-based electroactive material, where the silicon-based electroactive material includes a silicon oxide matrix and a plurality of silicon crystallites embedded therein. In certain instances, the heating may occur in an inert atmosphere such that the silicon crystallites are distributed throughout the silicon oxide matrix. In other instances, the heating may occur in a reducing environment such that the silicon crystallites are condensed in one or more regions in the silicon oxide matrix. In each instance, the silicon-based electroactive material may be carbon coated by heating the silicon-based electroactive material in an environment including hydrocarbons.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator and/or electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte, the solid-state electrolyte may physically separate the electrodes so that a distinct separator is not required.

Conventional rechargeable lithium-ion batteries operate by reversibly passing lithium ions back and forth between the negative electrode and the positive electrode. For example, lithium ions may move from the positive electrode to the negative electrode during charging of the battery, and in the opposite direction when discharging the battery. Such lithium-ion batteries can reversibly supply power to an associated load device on demand. More specifically, electrical power can be supplied to a load device by the lithium-ion battery until the lithium content of the negative electrode is effectively depleted. The battery may then be recharged by passing a suitable direct electrical current in the opposite direction between the electrodes.

During discharge, the negative electrode may contain a comparatively high concentration of intercalated lithium, which is oxidized into lithium ions releasing electrons. Lithium ions may travel from the negative electrode to the positive electrode, for example, through the ionically conductive electrolyte solution contained within the pores of an interposed porous separator. Concurrently, electrons pass through an external circuit from the negative electrode to the positive electrode. Such lithium ions may be assimilated into the material of the positive electrode by an electrochemical reduction reaction. The battery may be recharged or regenerated after a partial or full discharge of its available capacity by an external power source, which reverses the electrochemical reactions that transpired during discharge.

In various instances, however, a portion of the intercalated lithium remains with the negative electrode following the first cycle due to, for example, conversion reactions and/or the formation of a solid electrolyte interphase (“SEI”) layer on the negative electrode during the first cycle, as well as ongoing lithium loss due to, for example, continuous solid electrolyte interphase breakage. Such permanent loss of lithium ions may result in a decreased specific energy and power in the battery resulting from, for example, added positive electrode mass that does not participate in the reversible operation of the battery. For example, the lithium-ion battery may experience an irreversible capacity loss of greater than or equal to about 5% to less than or equal to about 30% after the first cycle, and in the instance of silicon-containing negative electrodes (e.g., SiOₓ), or other volume-expanding negative electroactive materials (e.g., tin (Sn), aluminum (Al), germanium (Ge)), an irreversible capacity loss of greater than or equal to about 20% to less than or equal to about 40% after the first cycle.

Current methods to compensate for first cycle lithium loss include, for example, electrochemical processes where a silicon-containing anode is lithiated using an electrolyte bath, paired with lithium source such as lithium metal or lithium containing transition metal oxides. However, such processes are susceptible to air and moisture, and as a result, instability. Another method of compensation includes, for example, in-cell lithiation, which includes adding lithium to a cell. Such processes, however, often require the use of mesh current collectors, which have high material costs, as well as coating costs. Yet another method of compensation includes, for example, the deposition (e.g., spraying or extrusion or physical vapor deposition (“PVD”)) of lithium on an anode or anode material. However, in such instances, it is difficult (and costly) to produce evenly deposited lithium layers. Accordingly, it would be desirable to develop improved electrodes and electroactive materials, and methods of using the same, that can address these challenges.

### SUMMARY

This section provides a general summary of the disclosure, and is not a comprehensive disclosure of its full scope or all of its features.

The present disclosure relates to electroactive materials for use in an electrochemical cell that cycles lithium material, for example in the negative electrode as a negative electroactive material, and methods of forming and using the same. The electroactive materials include, for example, nanosized silicon crystallites embedded within a matrix defined by silicon oxide (SiOₓ, where 0.1≤x≤2), where silicon oxide matrix protects the embedded silicon from the electrolyte, so as to help avoid the formation of unstable solid state electrolyte (“SEI”) layers.

In various aspects, the present disclosure provides a method for preparing a silicon-based electroactive material for use in an electrochemical cell. The method may include heating a silicon oxide (SiOₓ, where 0.1≤x≤2) particle to a temperature of greater than or equal to about 600° C. to less than or equal to about 1200° C. over a period of greater than or equal to about 30 minutes to less than or equal to about 10 hours to form the silicon-based electroactive material, where the silicon-based electroactive material includes a silicon oxide matrix and a plurality of silicon crystallites embedded therein.

In one aspect, the heating of the silicon oxide (SiOₓ, where 0.1≤x≤2) particle may be conducted in an inert atmosphere, and the silicon crystallites may be distributed throughout the silicon oxide matrix.

In one aspect, the silicon-based electroactive material may have an amount of silicon to silicon oxide (Si/SiOₓ) of greater than or equal to about 15% to less than or equal to about 75%.

In one aspect, the heating of the silicon oxide (SiOₓ, where 0.1≤x≤2) particle may be conducted in a reducing environment, and the silicon crystallites may be condensed in one or more regions in the silicon oxide matrix.

In one aspect, the silicon-based electroactive material may have an amount of silicon to silicon oxide (Si/SiOₓ) of greater than or equal to about 15% to less than or equal to about 90%.

In one aspect, the heating of the silicon oxide (SiOₓ, where 0.1≤x≤2) particle may be conducted at a rate of greater than or equal to about 10° C. per minute to less than or equal to about 20° C. per minute to the temperature, and maintained at the temperature for greater than or equal to about 30 minutes to less than or equal to about 10 hours.

In one aspect, the temperature may be a first temperature, and the period may be a first period. The method may further include heating of the silicon-based electroactive material to a second temperature of greater than or equal to about 600° C. to less than or equal to about 1200° C. over a second period greater than or equal to about 30 minutes to less than or equal to about 10 hours in an environment comprising one or more hydrocarbon to form one or more substantially continuous carbon coatings on exposed surfaces of the silicon-based electroactive material.

In one aspect, the method may further include preparing the silicon oxide (SiOₓ, where 0.1≤x≤2) particle prior to the heating. Preparing the silicon oxide (SiOₓ, where 0.1≤x≤2) particle may include ball milling a silicon oxide (SiOₓ, where 0.1≤x≤2) precursor such that the silicon oxide (SiOₓ, where 0.1≤x≤2) particle has a particle size of greater than or equal to about 1 μm to less than or equal to about 3 μm.

In one aspect, the silicon-based electroactive material may have an average particle size of greater than or equal to about 500 nm to less than or equal to about 10 μm, and the silicon crystallites may have an average particle size of greater than or equal to about 5 nm to less than or equal to about 100 nm.

In various aspects, the present disclosure provides a method for preparing a silicon-based electroactive material for use in an electrochemical cell. The method may include heating a silicon oxide (SiOₓ, where 0.1≤x≤2) particle at a rate of greater than or equal to about 10° C. per minute to less than or equal to about 20° C. per minute to a temperature of greater than or equal to about 600° C. to less than or equal to about 1200° C. and maintaining the first temperature for a period of greater than or equal to about 30 minutes to less than or equal to about 10 hours. The silicon-based electroactive material may include a silicon oxide matrix and a plurality of silicon crystallites embedded therein, where the silicon-based electroactive material has an average particle size of greater than or equal to about 500 nm to less than or equal to about 10 μm, and the silicon crystallites have an average particle size of greater than or equal to about 5 nm to less than or equal to about 100 nm.

In one aspect, the heating of the silicon oxide (SiOₓ, where 0.1≤x≤2) particle may be conducted in an inert atmosphere, and the silicon crystallites may be distributed throughout the silicon oxide matrix.

In one aspect, the silicon-based electroactive material may have an amount of silicon to silicon oxide (Si/SiOₓ) of greater than or equal to about 15% to less than or equal to about 75%.

In one aspect, the heating of the silicon oxide (SiOₓ, where 0.1≤x≤2) particle may be conducted in a reducing environment, and the silicon crystallites may be condensed in one or more regions in the silicon oxide matrix.

In one aspect, the silicon-based electroactive material may have an amount of silicon to silicon oxide (Si/SiOₓ) of greater than or equal to about 15% to less than or equal to about 90%.

In one aspect, the temperature may a first temperature, and the period may be a first period. The method may further include heating of the silicon-based electroactive material to a second temperature of greater than or equal to about 600° C. to less than or equal to about 1200° C. over a second period of greater than or equal to about 30 minutes to less than or equal to about 10 hours in an environment comprising one or more hydrocarbon to form one or more substantially continuous carbon coatings on exposed surfaces of the silicon-based electroactive material.

In one aspect, the method may further include preparing the silicon oxide (SiOₓ, where 0.1≤x≤2) particle. Preparing the silicon oxide (SiOₓ, where 0.1≤x≤2) particle may include ball milling a silicon oxide (SiOₓ, where 0.1≤x≤2) precursor such that the silicon oxide (SiOₓ, where 0.1≤x≤2) particle have a particle size greater than or equal to about 1 μm to less than or equal to about 3 μm.

In various aspects, the present disclosure provides a silicon-based electroactive material for use in an electrochemical cell. The silicon-based electroactive material may include a silicon oxide matrix and a plurality of silicon crystallites embedded therein. The silicon-based electroactive material may have an average particle size of greater than or equal to about 500 nm to less than or equal to about 10 μm. The silicon crystallites may have an average particle size of greater than or equal to about 5 nm to less than or equal to about 100 nm. An amount of silicon to silicon oxide (Si/SiOₓ) in the silicon-based electroactive material may be greater than or equal to about 15% to less than or equal to about 90%.

In one aspect, the silicon crystallites may be distributed throughout the silicon oxide matrix.

In one aspect, the silicon crystallites may be condensed in one or more regions in the silicon oxide matrix.

In one aspect, the silicon-based electroactive particle may further include one or more carbon coatings on one or more exposed surfaces of the silicon-based electroactive particle. The one or more carbon coatings may have a cumulative thickness greater than or equal to about 5 nm to less or equal to about 500 nm.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic of an example electrochemical battery cell;

FIG. 2A is an illustration of an example silicon-based electroactive material having a silicon oxide matrix and a plurality of silicon particles embedded therein in accordance with various aspects of the present disclosure, for use as a negative electroactive material in an electrochemical cell, like the electrochemical battery cell illustrated in FIG. 1;

FIG. 2B is an illustration of another example silicon-based electroactive material having a silicon oxide matrix and a plurality of silicon particles embedded therein in accordance with various aspects of the present disclosure, for use as a negative electroactive material in an electrochemical cell, like the electrochemical battery cell illustrated in FIG. 1;

FIG. 3A illustrates an example method for forming a silicon-based electroactive material including nanosized silicon crystallites embedded within a matrix defined by silicon oxide (SiOₓ, where 0.1≤x≤2), where the silicon crystallites are substantially distributed throughout the silicon oxide matrix, such as illustrated in FIG. 2A;

FIG. 3B illustrates an example method for forming a silicon-based electroactive material including nanosized silicon crystallites embedded within a matrix defined by silicon oxide (SiOₓ, where 0.1≤x≤2), where the silicon crystallites are distributed in one or more regions in the silicon oxide matrix, such as illustrated in FIG. 2B; and

FIG. 4 is a graphical illustration demonstrating cycle stability of example battery cells prepared in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

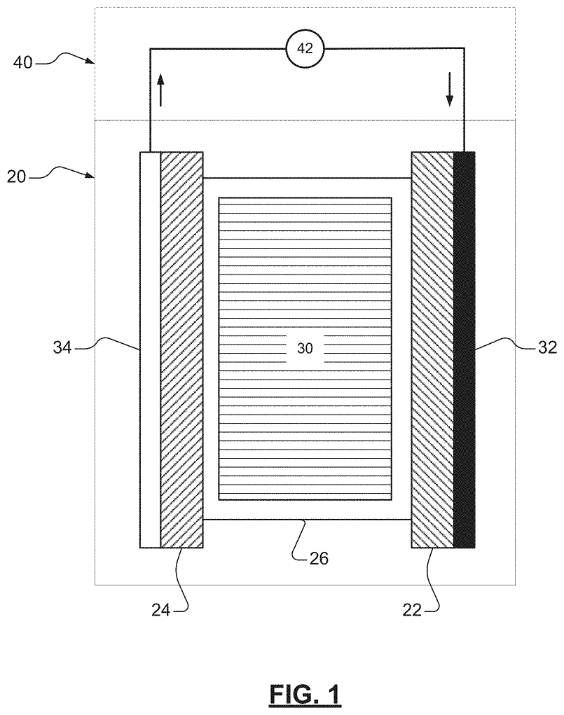

A typical lithium-ion battery includes a first electrode (such as a positive electrode or cathode) opposing a second electrode (such as a negative electrode or anode) and a separator and/or electrolyte disposed therebetween. Often, in a lithium-ion battery pack, batteries or cells may be electrically connected in a stack or winding configuration to increase overall output. Lithium-ion batteries operate by reversibly passing lithium ions between the first and second electrodes. For example, lithium ions may move from a positive electrode to a negative electrode during charging of the battery, and in the opposite direction when discharging the battery. The electrolyte is suitable for conducting lithium ions (or sodium ions in the case of sodium-ion batteries, and the like) and may be in liquid, gel, or solid form. For example, an exemplary and schematic illustration of an electrochemical cell (also referred to as the battery) 20 is shown in FIG. 1.

Such cells are used in vehicle or automotive transportation applications (e.g., motorcycles, boats, tractors, buses, motorcycles, mobile homes, campers, and tanks). However, the present technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples include a single positive electrode cathode and a single anode, the skilled artisan will recognize that the present teachings extend to various other configurations, including those having one or more cathodes and one or more anodes, as well as various current collectors with electroactive layers disposed on or adjacent to one or more surfaces thereof.

The battery 20 includes a negative electrode 22 (e.g., anode), a positive electrode 24 (e.g., cathode), and a separator 26 disposed between the two electrodes 22, 24. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and positive electrode 24. In certain variations, the separator 26 may be formed by a solid-state electrolyte or a semi-solid-state electrolyte (e.g., gel electrolyte). For example, the separator 26 may be defined by a plurality of solid-state electrolyte particles (not shown). In the instance of solid-state batteries and/or semi-solid-state batteries, the positive electrode 24 and/or the negative electrode 22 may include a plurality of solid-state electrolyte particles. The plurality of solid-state electrolyte particles included in, or defining, the separator 26 may be the same as or different from the plurality of solid-state electrolyte particles included in the positive electrode 24 and/or the negative electrode 22.

A negative electrode current collector 32 may be positioned at or near the negative electrode 22. The negative electrode current collector 32 may be a metal foil, metal grid or screen, or expanded metal comprising copper or any other appropriate electrically conductive material known to those of skill in the art. A positive electrode current collector 34 may be positioned at or near the positive electrode 24. The positive electrode current collector 34 may be a metal foil, metal grid or screen, or expanded metal comprising aluminum or any other appropriate electrically conductive material known to those of skill in the art. The negative electrode current collector 32 and the positive electrode current collector 34 respectively collect and move free electrons to and from an external circuit 40. For example, an interruptible external circuit 40 and a load device 42 may connect the negative electrode 22 (through the negative electrode current collector 32) and the positive electrode 24 (through the positive electrode current collector 34).

The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the negative electrode current collector 32, negative electrode 22, separator 26, positive electrode 24, and positive electrode current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. In certain aspects, the electrolyte 30 may be a non-aqueous liquid electrolyte solution (e.g., >1M) that includes a lithium salt dissolved in an organic solvent or a mixture of organic solvents. Numerous conventional non-aqueous liquid electrolyte 30 solutions may be employed in the lithium-ion battery 20.

In certain aspects, the electrolyte 30 may be a non-aqueous liquid electrolyte solution that includes one or more lithium salts dissolved in an organic solvent or a mixture of organic solvents. For example, a non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF6), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof.

These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane), sulfur compounds (e.g., sulfolane), and combinations thereof.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic materials and a heat-resistant material. For example, the separator 26 may also be admixed with the ceramic material and/or the heat-resistant material, or one or more surfaces of the separator 26 may be coated with the ceramic material and/or the heat-resistant material. In certain variations, the ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: Nomex, Aramid, and combinations thereof.

Various conventionally available polymers and commercial products for forming the separator 26 are contemplated, as well as the many manufacturing methods that may be employed to produce such a microporous polymer separator 26. In each instance, the separator 26 may have a thickness greater than or equal to about 1 μm to less than or equal to about 50 μm, and in certain instances, optionally greater than or equal to about 1 μm to less than or equal to about 20 μm. The separator 26 may have a thickness greater than or equal to 1 μm to less than or equal to 50 μm, and in certain instances, optionally greater than or equal to 1 μm to less than or equal to 20 μm.

In various aspects, the porous separator 26 and/or the electrolyte 30 disposed in the porous separator 26 as illustrated in FIG. 1 may be replaced with a solid-state electrolyte (“SSE”) layer (not shown) and/or semi-solid-state electrolyte (e.g., gel) layer that functions as both an electrolyte and a separator. The solid-state electrolyte layer and/or semi-solid-state electrolyte layer may be disposed between the positive electrode 24 and negative electrode 22. The solid-state electrolyte layer and/or semi-solid-state electrolyte layer facilitates transfer of lithium ions, while mechanically separating and providing electrical insulation between the negative and positive electrodes 22, 24. By way of non-limiting example, the solid-state electrolyte layer and/or semi-solid-state electrolyte layer may include a plurality of solid-state electrolyte particles, such as LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99} Ba_{0.005}ClO, or combinations thereof. The solid-state electrolyte particles may be nanometer sized oxide-based solid-state electrolyte particles.

The positive electrode 24 may be formed from a lithium-based active material (or a sodium-based active material in the instance of sodium-ion batteries or the like) that is capable of undergoing lithium intercalation and deintercalation, alloying and dealloying, or plating and stripping, while functioning as the positive terminal of the battery 20. The positive electrode 24 can be defined by a plurality of electroactive material particles (not shown). Such positive electroactive material particles may be disposed in one or more layers so as to define the three-dimensional structure of the positive electrode 24. The electrolyte 30 may be introduced, for example after cell assembly, and contained within pores (not shown) of the positive electrode 24. For example, in certain variations, the positive electrode 24 may include a plurality of solid-state electrolyte particles (not shown). In each instance, the positive electrode 24 may have a thickness greater than or equal to about 1 μm to less than or equal to about 500 μm, and in certain aspects, optionally greater than or equal to about 10 μm to less than or equal to about 200 μm. The positive electrode 24 may have a thickness greater than or equal to 1 μm to less than or equal to 500 μm, and in certain aspects, optionally greater than or equal to 10 μm to less than or equal to 200 μm.

One exemplary common class of known materials that can be used to form the positive electrode 24 is layered lithium transitional metal oxides. For example, in certain aspects, the positive electrode 24 may comprise one or more materials having a spinel structure, such as lithium manganese oxide (Li₍₁₊ₓ₎Mn₂O₄, where 0.1≤x≤1) (LMO), lithium manganese nickel oxide (LiMn₍₂₋ₓ₎)NiₓO₄, where 0≤x≤0.5) (NMC) (e.g., LiMn_{1.5}Ni_{0.5}O₄); one or more materials with a layered structure, such as lithium cobalt oxide (LiCoO₂), lithium nickel manganese cobalt oxide (Li(NiₓMn_{y}Co_{z})O₂, where 0≤x≤1, 0≤y≤1, 0≤z≤1, and x+y+z=1) (e.g., LiMn_{0.33}Ni_{0.33}Co_{0.}33O₂), or a lithium nickel cobalt metal oxide (LiNi_{(1-x-y)}CoₓM_{y}O₂, where 0<x<0.2, y<0.2, and M may be Al, Mg, Ti, or the like); or a lithium iron polyanion oxide with olivine structure, such as lithium iron phosphate (LiFePO₄) (LFP), lithium manganese-iron phosphate (LiMn₂₋ₓFeₓPO₄, where 0<x<0.3) (LFMP), or lithium iron fluorophosphate (Li₂FePO₄F). In various aspects, the positive electrode 24 may comprise one or more electroactive materials selected from the group consisting of: NCM 111, NCM 532, NCM 622, NCM 811, NCMA, LFP, LMO, LFMP, LLC, and combinations thereof.

In certain variations, the positive electroactive material(s) in the positive electrode 24 may be optionally intermingled with an electronically conducting material that provides an electron conduction path and/or at least one polymeric binder material that improves the structural integrity of the electrode 24. For example, the positive electroactive material(s) in the positive electrode 24 may be optionally intermingled (e.g., slurry casted) with binders like polyimide, polyamic acid, polyamide, polysulfone, polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate. Electrically conducting materials may include carbon-based materials, powdered nickel or other metal particles, or a conductive polymer. Carbon-based materials may include, for example, particles of graphite, acetylene black (such as KETJEN™ black or DENKA™ black), carbon fibers and nanotubes, graphene, and the like. Examples of a conductive polymer include polyaniline, polythiophene, polyacetylene, polypyrrole, and the like. In certain aspects, mixtures of the conductive materials may be used.

The positive electrode 24 may include greater than or equal to about 5 wt. % to less than or equal to about 99 wt. %, optionally greater than or equal to about 10 wt. % to less than or equal to about 99 wt. %, and in certain variations, greater than or equal to about 50 wt. % to less than or equal to about 98 wt. %, of the positive electroactive material(s); greater than or equal to 0 wt. % to less than or equal to about 40 wt. %, and in certain aspects, optionally greater than or equal to about 1 wt. % to less than or equal to about 20 wt. %, of the electronically conducting material; and greater than or equal to 0 wt. % to less than or equal to about 40 wt. %, and in certain aspects, optionally greater than or equal to about 1 wt. % to less than or equal to about 20 wt. %, of the at least one polymeric binder.

The positive electrode 24 may include greater than or equal to 5 wt. % to less than or equal to 99 wt. %, optionally greater than or equal to 10 wt. % to less than or equal to 99 wt. %, and in certain variations, greater than or equal to 50 wt. % to less than or equal to 98 wt. %, of the positive electroactive material(s); greater than or equal to 0 wt. % to less than or equal to 40 wt. %, and in certain aspects, optionally greater than or equal to 1 wt. % to less than or equal to 20 wt. %, of the electronically conducting material; and greater than or equal to 0 wt. % to less than or equal to 40 wt. %, and in certain aspects, optionally greater than or equal to 1 wt. % to less than or equal to 20 wt. %, of the at least one polymeric binder.

The negative electrode 22 may be formed from a lithium host material (or a sodium-based active material in the instance of sodium-ion batteries or the like) that is capable of functioning as a negative terminal of the battery 20. In various aspects, the negative electrode 22 may be defined by a plurality of negative electroactive material particles (not shown). Such negative electroactive material particles may be disposed in one or more layers so as to define the three-dimensional structure of the negative electrode 22. The electrolyte 30 may be introduced, for example after cell assembly, and contained within pores (not shown) of the negative electrode 22. For example, in certain variations, the negative electrode 22 may include a plurality of solid-state electrolyte particles (not shown). In each instance, the negative electrode 22 (including the one or more layers) may have a thickness greater than or equal to about 1 μm to less than or equal to about 500 μm, and in certain aspects, optionally greater than or equal to about 10 μm to less than or equal to about 200 μm. The negative electrode 22 (including the one or more layers) may have a thickness greater than or equal to 1 μm to less than or equal to 500 μm, and in certain aspects, optionally greater than or equal to 10 μm to less than or equal to 200 μm.

In various aspects, the negative electroactive material may be a silicon-based electroactive material, and in further variations, the negative electroactive material may include a combination of the silicon-based electroactive material (i.e., first negative electroactive material) and one or more other negative electroactive materials. The one or more other negative electroactive materials include, for example only, carbonaceous materials (such as, graphite, hard carbon, soft carbon, and the like) and metallic active materials (such as tin, aluminum, magnesium, germanium, and alloys thereof, and the like). For example, in certain variations, the negative electroactive material may include a carbonaceous-silicon based composite including, for example, about 10 wt. % of a silicon-based electroactive material and about 90 wt. % graphite. The negative electroactive material may include a carbonaceous-silicon based composite including, for example, 10 wt. % of a silicon-based electroactive material and 90 wt. % graphite.

As discussed above, during discharge, the negative electrode 22 may contain a comparatively high concentration of lithium, which is oxidized into lithium ions and electrons. Lithium ions may travel from the negative electrode 22 to the positive electrode 24, for example, through the ionically conductive electrolyte 30 contained within the pores of an interposed porous separator 26. Concurrently, electrons pass through an external circuit 40 from the negative electrode 22 to the positive electrode 24. Such lithium ions may be assimilated into the material of the positive electrode 22 by an electrochemical reduction reaction. The battery 20 may be recharged or regenerated after a partial or full discharge of its available capacity by an external power source, which reverses the electrochemical reactions that transpired during discharge.

In certain instances, however, especially in instances of silicon-containing electroactive materials, a portion of the intercalated lithium often remains with the negative electrode 22. For example, as a result of conversion reactions and/or the formation of LiₓSi and/or a solid electrolyte interphase (SEI) layer (not shown) on the negative electrode 22 during the first cycle, as well as ongoing lithium loss due to, for example, continuous solid electrolyte interphase (SEI) breakage and rebuild. The solid electrolyte interface (SEI) layer can form over the surface of the negative electrode 22, which is often generated by electrolyte decomposition, which consumes, irreversibility, lithium ions. Such permanent loss of lithium ions may result in a decreased specific energy and power in the battery 20. For example, the battery 20 may experience an irreversible capacity loss of greater than or equal to about 5% to less than or equal to about 40% after the first cycle.

In various aspects, the present disclosure provides a silicon-based electroactive materials having a silicon oxide matrix and a plurality of silicon particles embedded therein, which may be used as a negative electroactive material in an electrochemical cell, like battery 20 illustrated in FIG. 1. In such instances, the silicon oxide matrix protects the embedded silicon from the electrolyte (e.g., electrolyte 30) thereby suppressing mechanical degradation of the silicon occurring during, and as a result of, the formation of a solid electrolyte interphase layer or layers on the silicon.

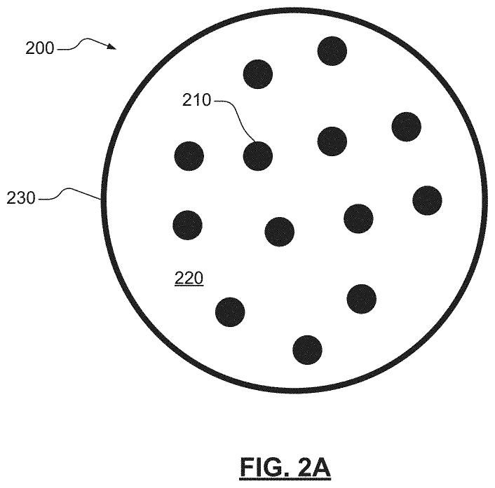

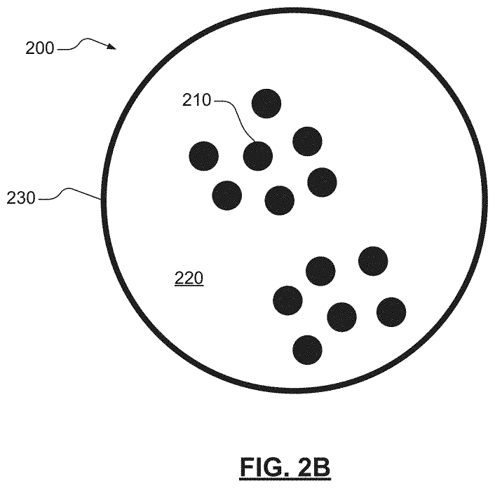

FIGS. 2A-2B illustrate a silicon-based electroactive material 200 including nanosized silicon crystallites 210 embedded within a matrix 220 defined by silicon oxide (SiOₓ, where 0.1≤x≤2). For example, the silicon-based electroactive material 200 may include an amount of silicon to silicon oxide (Si/SiOₓ) of greater than or equal to about 15% to less than or equal to about 90%, and in certain aspects, optionally greater than or equal to about 15% to less than or equal to about 75%. The silicon-based electroactive material 200 may include an amount of silicon to silicon oxide ratio (Si/SiOₓ) of greater than or equal to 15% to less than or equal to 90%, and in certain aspects, optionally greater than or equal to 15% to less than or equal to 75%.

In various aspects, the silicon-based electroactive material 200 may have an average particle size greater than or equal to about 500 nm to less than or equal to about 10 μm, and in certain aspects, optionally greater than or equal to about 50 nm to less than or equal to about 5 μm. The silicon-based electroactive material 200 may have an average particle size greater than or equal to 500 nm to less than or equal to about 10 μm, and in certain aspects, optionally greater than or equal to about 50 nm to less than or equal to about 5 μm. The silicon crystallites 210 may have an average crystal size greater than or equal to about 5 nm to less than or equal to about 100 nm, and in certain aspects, optionally greater than or equal to about 10 nm to less than or equal to about 500 nm. The silicon crystallites 210 may have an average crystal size greater than or equal to 5 nm to less than or equal to 100 nm, and in certain aspects, optionally greater than or equal to 10 nm to less than or equal to 500 nm.

In various aspects, as illustrated in FIG. 2A, the silicon crystallites 210 may be substantially dispersed or distributed throughout the silicon oxide matrix 220, for example, in the instance of lower amounts of silicon to silicon oxide (Si/SiOₓ). In such instances, the amount of silicon to silicon oxide (Si/SiOₓ) may be greater than or equal to about 15% to less than or equal to about 75%. The amount of silicon to silicon oxide (Si/SiOₓ) may be greater than or equal to 15% to less than or equal to 75%. In other variations, as illustrated in FIG. 2B, the silicon crystallites 210 may be condensed or concentrated in one or more regions in the silicon oxide matrix 220, for example, in the instance of higher amounts of silicon to silicon oxide (Si/SiOₓ). In such instances, the amount of silicon to silicon oxide ratio (Si/SiOₓ) may be greater than or equal to about 15% to less than or equal to about 90%. The amount of silicon to silicon oxide ratio (Si/SiOₓ) may be greater than or equal to 15% to less than or equal to 90%. Moreover, as further detailed below, the dispersion of the silicon crystallites 210 in the silicon oxide matrix 220 may depends on the formation process. For example, preparing the silicon-based electroactive material 200 in a reducing environment may cause the silicon crystallites 210 to be condensed in one or more regions in the silicon oxide matrix 220, as illustrated in FIG. 2B, while preparing the silicon-based electroactive material in an inert atmosphere may cause the silicon crystallites 210 to be substantially distributed throughout the silicon oxide matrix 220, as illustrated in FIG. 2A.

In each instance, the silicon-based electroactive material 200 may include a carbon coating 230 formed on exposed surface thereof, which may help to reduce internal resistance. As further detailed below, the carbon coating 230 may be prepared by exposing the silicon-based electroactive material 200 to one or more hydrocarbon gases (e.g., CH₄, C₂H₂, C₃H₆, and the like) in a high temperature environment (e.g., greater than or equal to about 600° C. to less than or equal to about 1200° C.). The carbon coating 230 may have a thickness greater than or equal to about 1 nm to less than or equal to about 500 nm, and in certain aspects, optionally greater than or equal to about 5 nm to less than or equal to about 50 nm. The carbon coating 230 may have a thickness greater than or equal to 1 nm to less than or equal to 500 nm, and in certain aspects, optionally greater than or equal to 5 nm to less than or equal to 50 nm.

The carbon coating 230 may be a substantially continuous coating, covering, for example, greater than or equal to about 80%, optionally greater than or equal to about 85%, optionally greater than or equal to about 90%, optionally greater than or equal to about 91%, optionally greater than or equal to about 92%, optionally greater than or equal to about 93%, optionally greater than or equal to about 94%, optionally greater than or equal to about 95%, optionally greater than or equal to about 96%, optionally greater than or equal to about 97%, optionally greater than or equal to about 98%, optionally greater than or equal to about 99%, and in certain aspects, optionally greater than or equal to about 99.5%, of a total exposed surface area of the silicon-based electroactive material 200.

The carbon coating 230 may be a substantially continuous coating, covering, for example, greater than or equal to 80%, optionally greater than or equal to 85%, optionally greater than or equal to 90%, optionally greater than or equal to 91%, optionally greater than or equal to 92%, optionally greater than or equal to 93%, optionally greater than or equal to 94%, optionally greater than or equal to 95%, optionally greater than or equal to 96%, optionally greater than or equal to 97%, optionally greater than or equal to 98%, optionally greater than or equal to 99%, and in certain aspects, optionally greater than or equal to 99.5%, of a total exposed surface area of the silicon-based electroactive material 200.

With renewed reference to FIG. 1, in certain variations, the negative electroactive material(s) in the negative electrode 22 may be optionally intermingled with one or more electrically conductive materials that provide an electron conductive path and/or at least one polymeric binder material that improves the structural integrity of the negative electrode 22. For example, the negative electroactive material(s) in the negative electrode 22 may be optionally intermingled (e.g., slurry casted) with binders like polyimide, polyamic acid, polyamide, polysulfone, polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate. Electrically conducting materials may include carbon-based materials, powdered nickel or other metal particles, or a conductive polymer. Carbon-based materials may include, for example, particles of graphite, acetylene black (such as KETCHEN™ black or DENKA™ black), carbon fibers and nanotubes, graphene, and the like. Examples of a conductive polymer include polyaniline, polythiophene, polyacetylene, polypyrrole, and the like. In certain aspects, mixtures of the conductive materials may be used.

The negative electrode 22 may include greater than or equal to about 5 wt. % to less than or equal to about 99 wt. %, optionally greater than or equal to about 10 wt. % to less than or equal to about 99 wt. %, and in certain variations, greater than or equal to about 50 wt. % to less than or equal to about 95 wt. %, of the negative electroactive material(s); greater than or equal to 0 wt. % to less than or equal to about 40 wt. %, and in certain aspects, optionally greater than or equal to about 1 wt. % to less than or equal to about 20 wt. %, of the electronically conducting material; and greater than or equal to 0 wt. % to less than or equal to about 40 wt. %, and in certain aspects, optionally greater than or equal to about 1 wt. % to less than or equal to about 20 wt. %, of the at least one polymeric binder.

The negative electrode 22 may include greater than or equal to 5 wt. % to less than or equal to 99 wt. %, optionally greater than or equal to 10 wt. % to less than or equal to 99 wt. %, and in certain variations, greater than or equal to 50 wt. % to less than or equal to 95 wt. %, of the negative electroactive material(s); greater than or equal to 0 wt. % to less than or equal to 40 wt. %, and in certain aspects, optionally greater than or equal to 1 wt. % to less than or equal to 20 wt. %, of the electronically conducting material; and greater than or equal to 0 wt. % to less than or equal to 40 wt. %, and in certain aspects, optionally greater than or equal to 1 wt. % to less than or equal to 20 wt. %, of the at least one polymeric binder.

In various aspects, the present disclosure provides methods for forming silicon-based electroactive materials having a silicon oxide matrix and a plurality of silicon particles embedded therein, such as the silicon-based electroactive materials illustrated in FIGS. 2A and 2B. The methods may generally include heating silicon oxide (SiOₓ, where 0.1≤x≤2), for example, to temperatures greater than or equal to about 600° C. to less than or equal to about 1200° C., and in certain aspects, optionally greater than or equal to about 900° C. to less than or equal to about 1100° C., over a period greater than or equal to about 30 minutes to less than or equal to about 10 hours, and in certain aspects, optionally greater than or equal to about 2 hours to less than or equal to about 6 hours, where shorter periods often have higher temperatures. The methods may generally include heating silicon oxide (SiOₓ, where 0.1≤x≤2), for example, to temperatures greater than or equal to 600° C. to less than or equal to 1200° C., and in certain aspects, optionally greater than or equal to 900° C. to less than or equal to 1100° C., over a period greater than or equal to 30 minutes to less than or equal to 10 hours, and in certain aspects, optionally greater than or equal to 2 hours to less than or equal to 6 hours, where shorter periods often have higher temperatures.

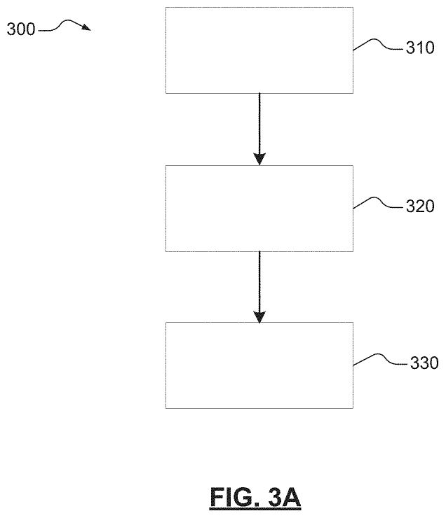

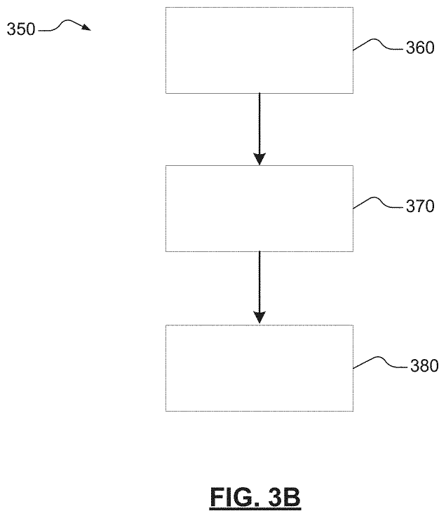

FIG. 3A illustrates an example method 300 for forming a silicon-based electroactive material including nanosized silicon crystallites embedded within a matrix defined by silicon oxide (SiOₓ, where 1≤x≤2), where the silicon crystallites are substantially distributed throughout the silicon oxide matrix, such as illustrated in FIG. 2A. Silicon-based electroactive materials prepared using method 300 may have an amount of silicon to silicon oxide (Si/SiOₓ) of greater than or equal to about 15% to less than or equal to about 75%. Silicon-based electroactive materials prepared using method 300 may have an amount of silicon to silicon oxide (Si/SiOₓ) of greater than or equal to 15% to less than or equal to 75%.

The method 300 includes heating 320 silicon oxide (SiOₓ, where 0.1≤x≤2) particles in an inert atmosphere. For example, the silicon oxide (SiOₓ, where 0.1≤x≤2) particles may be heated to temperatures greater than or equal to about 600° C. to less than or equal to about 1200° C., and in certain aspects, optionally greater than or equal to about 900° C. to less than or equal to about 1100° C., over a period greater than or equal to about 30 minutes to less than or equal to about 10 hours, and in certain aspects, optionally greater than or equal to about 2 hours to less than or equal to about 6 hours, where shorter periods often have higher temperatures, to form silicon-based electroactive material including nanosized silicon crystallites embedded within a matrix defined by silicon oxide (SiOₓ, where 1≤x≤2), where the silicon crystallites are substantially distributed throughout the silicon oxide matrix. In certain variations, the silicon oxide (SiOₓ, where 0.1≤x≤2) particles may be heated to temperatures greater than or equal to 600° C. to less than or equal to 1200° C., and in certain aspects, optionally greater than or equal to 900° C. to less than or equal to 1100° C., over a period greater than or equal to 30 minutes to less than or equal to 10 hours, and in certain aspects, optionally greater than or equal to 2 hours to less than or equal to 6 hours. In each instance, the inert atmosphere may include, for example, argon (Ar), helium (He), and/or nitrogen gas (N₂).

In certain variations, the silicon oxide (SiOₓ, where 0.1≤x≤2) particles may be heated at a rate of greater than or equal to about 10° C. per minute to less than or equal to about 20° C. per minute to temperatures greater than or equal to about 600° C. to less than or equal to about 1200° C., and in certain aspects, optionally greater than or equal to about 800° C. to less than or equal to about 1100° C.; and after reaching temperature, the silicon oxide (SiOₓ, where 0.1≤x≤2) particles may be held at the temperatures greater than or equal to about 600° C. to less than or equal to about 1200° C., and in certain aspects, optionally greater than or equal to about 800° C. to less than or equal to about 1100° C., for a period greater than or equal to about 30 minutes to less than or equal to about 10 hours, and in certain aspects, optionally greater than or equal to about 2 hours to less than or equal to about 6 hours.

In certain variations, the silicon oxide (SiOₓ, where 0.1≤x≤2) particles may be heated at a rate of greater than or equal to 10° C. per minute to less than or equal to 20° C. per minute to temperatures greater than or equal to 600° C. to less than or equal to 1200° C., and in certain aspects, optionally greater than or equal to 800° C. to less than or equal to 1100° C.; and after reaching temperature, the silicon oxide (SiOₓ, where 0.1≤x≤2) particles may be held at the temperatures greater than or equal to 600° C. to less than or equal to 1200° C., and in certain aspects, optionally greater than or equal to 800° C. to less than or equal to 1100° C., for a period greater than or equal to 30 minutes to less than or equal to 10 hours, and in certain aspects, optionally greater than or equal to 2 hours to less than or equal to 6 hours.

In various aspects, the method 300 may include preparing 310 the silicon oxide (SiOₓ, where 0.1≤x≤2) particles. In certain variations, preparing 310 the silicon oxide (SiOₓ, where 0.1≤x≤2) particles may include sizing precursor silicon oxide (SiOₓ, where 0.1≤x≤2) particles, for example using ball milling processes. The precursor silicon oxide (SiOₓ, where 0.1≤x≤2) particles may have an average particle size of about 5 μm. The precursor silicon oxide (SiOₓ, where 0.1≤x≤2) particles may have an average particle size of 5 μm. The silicon oxide (SiOₓ, where 0.1≤x≤2) particles, as prepared, may have an average particle size greater than or equal to about 1 μm to less than or equal to about 3 μm. The silicon oxide (SiOₓ, where 0.1≤x≤2) particles, as prepared, may have an average particle size greater than or equal to 1 μm to less than or equal to 3 μm. The smaller particle size often results in less mechanical and chemical degradations, and as such, longer cycle life.

In various aspects, the method 300 may further include heating 330 the silicon-based electroactive material in the presence of one or more hydrocarbon gases, such as CH₄, C₂H₂, C₃H₆, and the like. For example, the silicon-based electroactive material may be heated to temperatures greater than or equal to about 600° C. to less than or equal to about 1200° C., and in certain aspects, optionally greater than or equal to about 800° C. to less than or equal to about 1100° C., over a period greater than or equal to about 30 minutes to less than or equal to about 10 hours, and in certain aspects, optionally greater than or equal to about 2 hours to less than or equal to about 6 hours, where shorter periods often have higher temperatures, to from a substantially continuous carbon coating on exposed surfaces of the silicon-based electroactive material. In certain variations, the silicon-based electroactive material may be heated to temperatures greater than or equal to 600° C. to less than or equal to 1200° C., and in certain aspects, optionally greater than or equal to 800° C. to less than or equal to 1100° C., over a period greater than or equal to 30 minutes to less than or equal to 10 hours, and in certain aspects, optionally greater than or equal to 2 hours to less than or equal to 6 hours, in the presence of one or more hydrocarbon gases.

FIG. 3B illustrates an example method 350 for forming a silicon-based electroactive material including nanosized silicon crystallites embedded within a matrix defined by silicon oxide (SiOₓ, where 1≤x≤2), where the silicon crystallites are condensed in one or more regions in the silicon oxide matrix, such as illustrated in FIG. 2B. Silicon-based electroactive materials prepared using method 300 may have an amount of silicon to silicon oxide (Si/SiOₓ) of greater than or equal to about 15% to less than or equal to about 90%. Silicon-based electroactive materials prepared using method 300 may have an amount of silicon to silicon oxide (Si/SiOₓ) of greater than or equal to 15% to less than or equal to 90%.

The method 350 includes heating 370 silicon oxide (SiOₓ, where 0.1≤x≤2) particles in a reducing atmosphere. For example, the silicon oxide (SiOₓ, where 0.1≤x≤2) particles may be heated to temperatures greater than or equal to about 600° C. to less than or equal to about 1200° C., and in certain aspects, optionally greater than or equal to about 900° C. to less than or equal to about 1100° C., over a period greater than or equal to about 30 minutes to less than or equal to about 10 hours, and in certain aspects, optionally greater than or equal to about 2 hours to less than or equal to about 6 hours, where shorter periods often have higher temperatures, to form silicon-based electroactive material including nanosized silicon crystallites embedded within a matrix defined by silicon oxide (SiOₓ, where 1≤x≤2), where the silicon crystallites are condensed in one or more regions in the silicon oxide matrix. In certain variations, the silicon oxide (SiOₓ, where 0.1≤x≤2) particles may be heated to temperatures greater than or equal to 600° C. to less than or equal to 1200° C., and in certain aspects, optionally greater than or equal to 900° C. to less than or equal to 1100° C., over a period greater than or equal to 30 minutes to less than or equal to 10 hours, and in certain aspects, optionally greater than or equal to 2 hours to less than or equal to 6 hours. In each instance, the reducing atmosphere may include, for example, H₂, CO, or the like.

In certain variations, the silicon oxide (SiOₓ, where 0.1≤x≤2) particles may be heated at a rate of greater than or equal to about 10° C. per minute to less than or equal to about 20° C. per minute to temperatures greater than or equal to about 600° C. to less than or equal to about 1200° C., and in certain aspects, optionally greater than or equal to about 900° C. to less than or equal to about 1100° C.; and after reaching temperature, the silicon oxide (SiOₓ, where 0.1≤x≤2) particles may be held at the temperatures greater than or equal to about 600° C. to less than or equal to about 1200° C., and in certain aspects, optionally greater than or equal to about 900° C. to less than or equal to about 1100° C., for a period greater than or equal to about 30 minutes to less than or equal to about 10 hours, and in certain aspects, optionally greater than or equal to about 2 hours to less than or equal to about 6 hours.

In certain variations, the silicon oxide (SiOₓ, where 0.1≤x≤2) particles may be heated at a rate of greater than or equal to 10° C. per minute to less than or equal to 20° C. per minute to temperatures greater than or equal to 600° C. to less than or equal to 1200° C., and in certain aspects, optionally greater than or equal to 900° C. to less than or equal to 1100° C.; and after reaching temperature, the silicon oxide (SiOₓ, where 0.1≤x≤2) particles may be held at the temperatures greater than or equal to 600° C. to less than or equal to 1200° C., and in certain aspects, optionally greater than or equal to 900° C. to less than or equal to 1100° C., for a period greater than or equal to 30 minutes to less than or equal to 10 hours, and in certain aspects, optionally greater than or equal to 2 hours to less than or equal to 6 hours.

In various aspects, the method 350 may include preparing 360 the silicon oxide (SiOₓ, where 0.1≤x≤2) particles. In certain variations, preparing 360 the silicon oxide (SiOₓ, where 0.1≤x≤2) particles may include sizing precursor silicon oxide (SiOₓ, where 0.1≤x≤2) particles, for example using ball milling processes. The precursor silicon oxide (SiOₓ, where 0.1≤x≤2) particles may have an average particle size of about 5 μm. The precursor silicon oxide (SiOₓ, where 0.1≤x≤2) particles may have an average particle size of 5 μm. The silicon oxide (SiOₓ, where 0.1≤x≤2) particles, as prepared, may have an average particle size greater than or equal to about 1 μm to less than or equal to about 3 μm. The silicon oxide (SiOₓ, where 0.1≤x≤2) particles, as prepared, may have an average particle size greater than or equal to 1 μm to less than or equal to 3 μm. The smaller particle size often results in less mechanical and chemical degradations, and as such, longer cycle life.

In various aspects, the method 350 may further include heating 380 the silicon-based electroactive material in the presence of one or more hydrocarbon gases, such as CH₄, C₂H₂, C₃H₆, and the like. For example, the silicon-based electroactive material may be heated to temperatures greater than or equal to about 600° C. to less than or equal to about 1200° C., and in certain aspects, optionally greater than or equal to about 800° C. to less than or equal to about 1100° C., over a period greater than or equal to about 30 minutes to less than or equal to about 10 hours, and in certain aspects, optionally greater than or equal to about 2 hours to less than or equal to about 6 hours, where shorter periods often have higher temperatures, to from a substantially continuous carbon coating on exposed surfaces of the silicon-based electroactive material. In certain variations, the silicon-based electroactive material may be heated to temperatures greater than or equal to 600° C. to less than or equal to 1200° C., and in certain aspects, optionally greater than or equal to 800° C. to less than or equal to 1100° C., over a period greater than or equal to 30 minutes to less than or equal to 10 hours, and in certain aspects, optionally greater than or equal to 2 hours to less than or equal to 6 hours, in the presence of one or more hydrocarbon gases.

Certain features of the current technology are further illustrated in the following non-limiting example.

### Example

An example cell can be prepared in accordance with various aspects of the present disclosure. For example, in certain variations, silicon oxide (SiOₓ, where 0.1≤x≤2) particles having an average particle size of about 5 μm may be ball milled to prepare silicon oxide (SiOₓ, where 0.1≤x≤2) particles having an average particle size of about 1 μm. The silicon oxide (SiOₓ, where 0.1≤x≤2) particles having an average particle size of about 1 μm may be heat treated in an inert atmosphere, including, for example, argon, for about 5 hours at different temperatures ranging from about 800° C. to about 1,100° C. During the heating process, the silicon oxide (SiOₓ, where 0.1≤x≤2) particles are converted, via disproportionation reactions, to a silicon-based electroactive material including a silicon oxide (SiOₓ, where 0.1≤x≤2) matrix including nanocrystalline silicon embedded therein.

In each instance, the silicon oxide (SiOₓ, where 0.1≤x≤2) matrix including nanocrystalline silicon may be used as a negative electroactive material. For example, a first example silicon-based electroactive material 430 may be heated to about 800° C., a second example silicon-based electroactive material 432 may be heated to about 900° C., a third example silicon-based electroactive material 433 may be heated to about 1,000° C., and a fourth example silicon-based electroactive material 434 may be heated to about 1,100° C. The example heat-treated silicon-based electroactive materials 430, 432, 433, 434 can be compared to an example negative electroactive material including silicon 420 and an example negative electroactive material including untreated silicon oxide (SiOₓ, where 0.1≤x≤2) particles 422 having an average particle size of about 1 μm.

In each instance, the example silicon-electroactive material 420, 422, 430, 432, 433, 434 may be used to form example negative electrodes. For example, in each instance a slurry may be prepared that is coated, for example using a doctor blade, onto a current collector, such as a copper foil having a thickness of about 25 μm. Each slurry may also include an electronically conducting material (such as, carbon black) and/or a binder. For example, the example slurries may include about 70 wt. % of the negative electroactive material, about 15 wt. % of the electronically conducting material, and about 15 wt. % of the binder. The example slurries may include 70 wt. % of the negative electroactive material, 15 wt. % of the electronically conducting material, and 15 wt. % of the binder. Once coated onto the example current collectors, the slurries may be air-dried, for example in a fume hood, at room temperature for about one hour. In certain variations, the slurries may be further dried in a vacuum over having a temperature of about 75° C. for greater than or equal to about 8 hours, and in certain aspects, optionally greater than or equal to about 12 hours, so as to fully evaporate any remaining solvent.

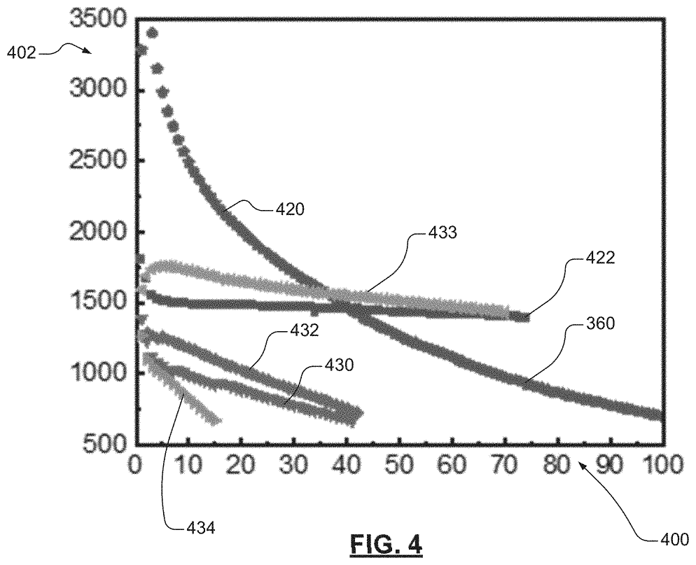

The example negative electrodes were each incorporated into separate coin cells including an example electrolyte. The electrolyte includes, for example, 1M LiPF₆ in ethylene carbonate and ethyl methyl carbonate (3:7 volume ratio). Galvanostatic discharge/charge tests were performed on the example cells using a voltage window greater than or equal to about 0.05 V to less than or equal to about 1.5 V (versus Li+/Li). As illustrated in FIG. 4, the example heat-treated silicon-based electroactive materials 430, 432, 433, 434 have superior first cycle efficiency and long-term cycle stability as compared to the example negative electroactive material including silicon 420 and the example negative electroactive material including untreated silicon oxide (SiOₓ, where 0.1≤x≤2) particles 422 having an average particle size of about 1 μm. The x-axis 400 represents cycle number. The y-axis 402 represents capacity (mAhg·g⁻¹).

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for preparing a silicon-based electroactive material for use in an electrochemical cell, the method comprising:
heating a silicon oxide (SiOₓ, where 0.1≤x≤2) particle to a temperature of greater than or equal to about 600° C. to less than or equal to about 1200° C. over a period of greater than or equal to about 30 minutes to less than or equal to about 10 hours to form the silicon-based electroactive material, wherein the silicon-based electroactive material comprises a silicon oxide matrix and a plurality of silicon crystallites embedded therein.

2. The method of claim 1, wherein the heating of the silicon oxide (SiOₓ, where 0.1≤x≤2) particle is conducted in an inert atmosphere, and the silicon crystallites are distributed throughout the silicon oxide matrix.

3. The method of claim 2, wherein the silicon-based electroactive material has an amount of silicon to silicon oxide (Si/SiOₓ) of greater than or equal to about 15% to less than or equal to about 75%.

4. The method of claim 1, wherein the heating of the silicon oxide (SiOₓ, where 0.1≤x≤2) particle is conducted in a reducing environment, and the silicon crystallites are condensed in one or more regions in the silicon oxide matrix.

5. The method of claim 1, wherein the silicon-based electroactive material has an amount of silicon to silicon oxide (Si/SiOₓ) of greater than or equal to about 15% to less than or equal to about 90%.

6. The method of claim 1, wherein the heating of the silicon oxide (SiOₓ, where 0.1≤x≤2) particle is conducted at a rate of greater than or equal to about 10° C. per minute to less than or equal to about 20° C. per minute to the temperature, and maintained at the temperature for greater than or equal to about 30 minutes to less than or equal to about 10 hours.

7. The method of claim 1, wherein the temperature is a first temperature and the period is a first period, the method further comprises:
heating of the silicon-based electroactive material to a second temperature of greater than or equal to about 600° C. to less than or equal to about 1200° C. over a second period greater than or equal to about 30 minutes to less than or equal to about 10 hours in an environment comprising one or more hydrocarbon to form one or more substantially continuous carbon coatings on exposed surfaces of the silicon-based electroactive material.

8. The method of claim 1, further comprising:
preparing the silicon oxide (SiOₓ, where 0.1≤x≤2) particle prior to the heating, wherein the preparing the silicon oxide (SiOₓ, where 0.1≤x≤2) particle comprises ball milling a silicon oxide (SiOₓ, where 0.1≤x≤2) precursor, and the silicon oxide (SiOₓ, where 0.1≤x≤2) particle has a particle size of greater than or equal to about 1 μm to less than or equal to about 3 μm.

9. The method of claim 1, wherein the silicon-based electroactive material has an average particle size of greater than or equal to about 500 nm to less than or equal to about 10 μm, and the silicon crystallites have an average particle size of greater than or equal to about 5 nm to less than or equal to about 100 nm.

10. A method for preparing a silicon-based electroactive material for use in an electrochemical cell, the method comprising:
heating a silicon oxide (SiOₓ, where 0.1≤x≤2) particle at a rate of greater than or equal to about 10° C. per minute to less than or equal to about 20° C. per minute to a temperature of greater than or equal to about 600° C. to less than or equal to about 1200° C. and maintaining the first temperature for a period of greater than or equal to about 30 minutes to less than or equal to about 10 hours, wherein the silicon-based electroactive material comprises a silicon oxide matrix and a plurality of silicon crystallites embedded therein, wherein the silicon-based electroactive material has an average particle size of greater than or equal to about 500 nm to less than or equal to about 10 μm, and the silicon crystallites have an average particle size of greater than or equal to about 5 nm to less than or equal to about 100 nm.

11. The method of claim 10, wherein the heating of the silicon oxide (SiOₓ, where 0.1≤x≤2) particle is conducted in an inert atmosphere, and the silicon crystallites are distributed throughout the silicon oxide matrix.

12. The method of claim 11, wherein the silicon-based electroactive material has an amount of silicon to silicon oxide (Si/SiOₓ) of greater than or equal to about 15% to less than or equal to about 75%.

13. The method of claim 10, wherein the heating of the silicon oxide (SiOₓ, where 0.1≤x≤2) particle is conducted in a reducing environment, and the silicon crystallites are condensed in one or more regions in the silicon oxide matrix.

14. The method of claim 13, wherein the silicon-based electroactive material has an amount of silicon to silicon oxide (Si/SiOₓ) of greater than or equal to about 15% to less than or equal to about 90%.

15. The method of claim 10, wherein the temperature is a first temperature and the period is a first period, the method further comprises:
heating of the silicon-based electroactive material to a second temperature of greater than or equal to about 600° C. to less than or equal to about 1200° C. over a second period of greater than or equal to about 30 minutes to less than or equal to about 10 hours in an environment comprising one or more hydrocarbon to form one or more substantially continuous carbon coatings on exposed surfaces of the silicon-based electroactive material.

16. The method of claim 10, further comprising:
preparing the silicon oxide (SiOₓ, where 0.1≤x≤2) particle, wherein preparing the silicon oxide (SiOₓ, where 0.1≤x≤2) particle comprises ball milling a silicon oxide (SiOₓ, where 0.1≤x≤2) precursor, and the silicon oxide (SiOₓ, where 0.1≤x≤2) particle has a particle size greater than or equal to about 1 μm to less than or equal to about 3 μm.

17. A silicon-based electroactive material for use in an electrochemical cell, the silicon-based electroactive material comprising:
a silicon oxide matrix and a plurality of silicon crystallites embedded therein, wherein the silicon-based electroactive material has an average particle size of greater than or equal to about 500 nm to less than or equal to about 10 μm, the silicon crystallites have an average particle size of greater than or equal to about 5 nm to less than or equal to about 100 nm, and an amount of silicon to silicon oxide (Si/SiOₓ) is greater than or equal to about 15% to less than or equal to about 90%.

18. The silicon-based electroactive material of claim 17, wherein the silicon crystallites are distributed throughout the silicon oxide matrix.

19. The silicon-based electroactive material of claim 17, wherein the silicon crystallites are condensed in one or more regions in the silicon oxide matrix.

20. The silicon-based electroactive material of claim 17, wherein the silicon-based electroactive particle further comprises:
one or more carbon coatings having a cumulative thickness greater than or equal to about 5 nm to less or equal to about 500 nm on one or more exposed surfaces of the silicon-based electroactive particle.
